(19) United States
(12) Patent Application Publication
(10) Pub. No.: US 2014/0112494 A1
(43) Pub. Date: Apr. 24, 2014

(54) WIRELESS SPEAKER WITH TABLET COMPUTER STAND

(71) Applicant: BBY SOLUTIONS, INC., (US)

(72) Inventor: Chan Kei Lee, TaiWai (HK)

(73) Assignee: BBY SOLUTIONS, INC., Richfield, MN (US)

(21) Appl. No.: 13/658,162

(22) Filed: Oct. 23, 2012

(51) Int. Cl. H04R 1/02

(52) U.S. Cl. CPC H04R 1/021
USPC 381/77; 381/332; 29/428

(57) ABSTRACT

A wireless speaker stand for a tablet computer is presented. The speaker stand comprises a wireless audio speaker within a base. A channel within the base has a channel floor, a channel front wall, and a channel rear wall. One or more spring-mounted bumpers retractably protrude into the channel. A mobile electronic device may be inserted into the channel. The spring-mounted bumper exerts variable force upon the mobile device as it enters the channel, securing the mobile electronic device within in the channel.

### FIELD OF THE INVENTION

The present application relates to the field of wireless speaker stands. More particularly, the described embodiments relate to a wireless speaker stand having spring-mounted bumpers providing resistive force on a tablet computer in the speaker stand.

### SUMMARY

A disclosed embodiment of a wireless speaker stand includes a base having a channel within the base to hold a wireless mobile electronic device. One or more spring-mounted bumpers are partially recessed inside the speaker base and partially protrude into the channel. When the mobile device is inserted into the channel, a back side of the mobile device rests on a back wall of the channel. The bumpers provide a pushing force against a front side of the mobile device to steady the device and keep it upright in the stand.

### BRIEF DESCRIPTION OF THE DRAWINGS

FIG. 1 is a perspective view of a wireless speaker stand.

FIG. 2 is a side view of the wireless speaker stand coupled with a mobile electronic device.

FIG. 3 is a top view of the wireless speaker stand.

FIG. 4 is an exploded view of a speaker stand bumper assembly.

FIG. 5 is a schematic diagram of electronic components within the wireless speaker stand.

FIG. 6 is a flow chart demonstrating a method for using a wireless speaker stand.

### DETAILED DESCRIPTION

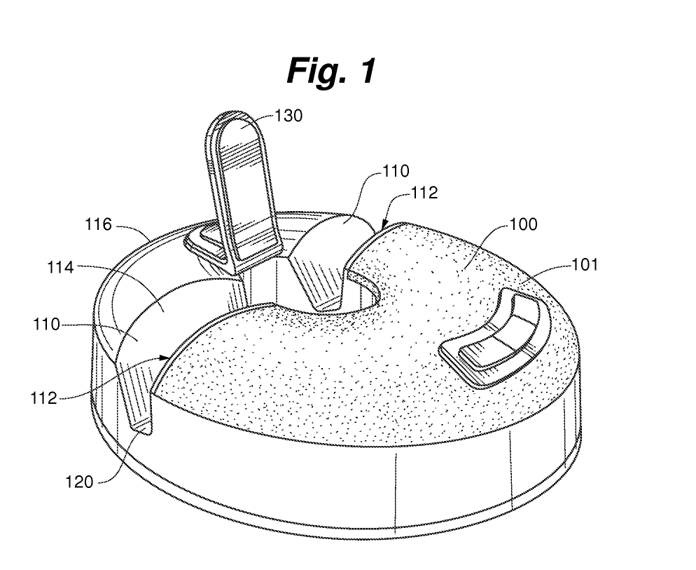

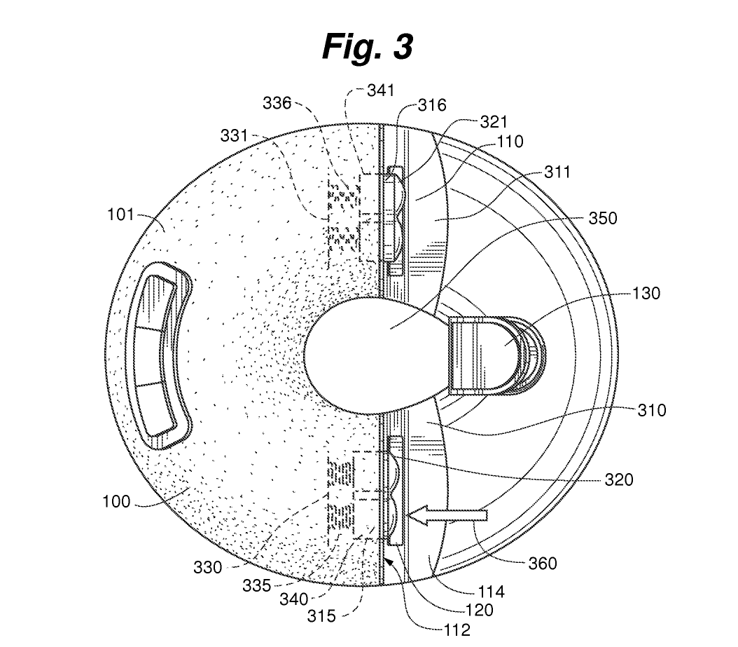

FIG. 1 shows a wireless speaker stand 100 having a base 101. The wireless speaker stand 100 is able to support a mobile device (not shown) and play back audio from the device via a wireless audio signal transmitted by the device. A slot or channel 110 intersects base 101 and is suitably sized to receive the mobile device. In the preferred embodiment, the base 101 has a rounded shape with an open center, as is shown more clearly in FIG. 3. The channel 110 passes from one end of the base 101, through this open center, and through the other end of the base 101. The channel 110 has a channel floor 120, a channel front wall 112, and a channel back wall 114. A support member 130 provides an additional surface on which the mobile device may rest when inserted into the stand 100. In the preferred embodiment, the base rests on a horizontal surface. In this position, the channel back wall 114 does not rise completely vertically, but slants toward the rear 116 of the base 101. In one embodiment, the channel back wall 114 is angled approximately 30 degrees from vertical. With a sloped embodiment, the slope can range from 10 to 45 degrees, but ideally the slope is between 20 and 40 degrees from vertical. The support member 130 preferably continues a similar slant, thereby allowed a back side of a mobile device to rest both against the channel back wall 114 and the support member 130 while resting in a slanted position on the channel floor 120. In another embodiment, the support member 130 has a slant that is slightly less (4-10 degrees) away from vertical than the channel back wall 114 and is design to be flexible enough as to conform to the slope of the channel back wall 114 when a mobile device is inserted into the channel 110.

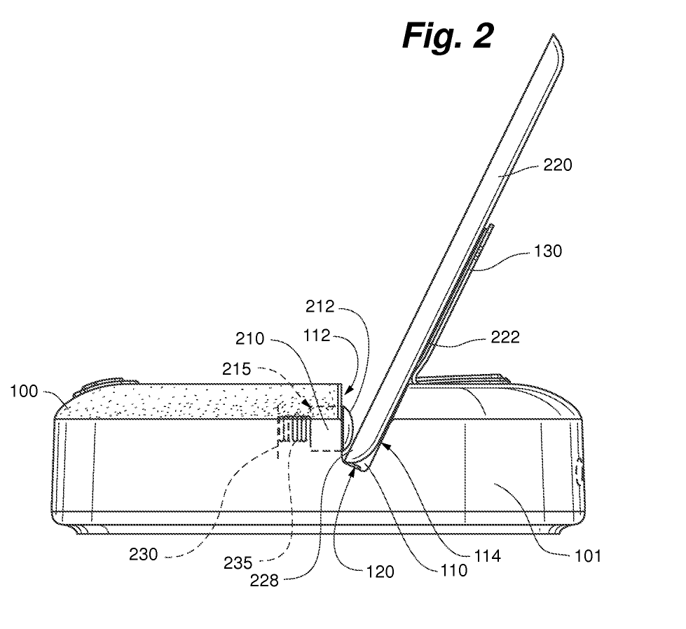

FIG. 2 shows wireless speaker stand 100 being used as a stand for an electronic mobile device 220. Device 220 may be an electronic device such as a tablet computer, gaming device, e-reader, smartphone, GPS device, or other mobile device having a visual display and sound output. In a preferred embodiment, device 220 has wireless communication capability to wirelessly send audio signals to speaker stand 100. Stand 100 may then play back the audio with internal speakers (not shown) found within the speaker stand 100.

The stand 100 is constructed to support devices of different thicknesses. Channel 110 within base 101 has a channel front wall 112, and channel rear wall 114. A retractably protruding bumper 210 is partially retracted into base 101 and partially protrudes into channel 110 through a cutout in channel front wall 112. Bumper 210 has a recessed end 215, and an abutting end 212 that abuts a bottom end 228 of mobile device 220 when mobile device 220 is inserted into the channel 110. Abutting end 212 may have a rounded or arcuate shape. Bumper 210 is preferably constructed from a material that will not scratch a screen of device 220. For example, bumper 210 could be made of a rubberized polymer material. A fixed contact surface 230 is provided inside the base 101. A spring 235 compressed between contact surface 230 and the bumper 210 provides an outward force to cause bumper 210 to retractably protrude into the channel 110. While the spring 235 shown in FIG. 2 is a coil spring, other known types of devices that provide a resistance to a compression force could be used in place of the coil spring 235.

When a user inserts mobile device 220 into channel 110, the bottom end 228 of the device first engages the rounded top of the abutting end 212 of the bumper 210. The arcuate contour of abutting end 212 allows the end 228 to slide smoothly down toward the channel floor 120. As the bottom end 228 descends toward channel floor 120, end 228 displaces bumper 210 and causes the bumper 210 to retract into the base 101. It is not necessary that the mobile device 220 be inserted into the channel 110 at an angle parallel to the channel back wall 114. Because of the rounded (or angled) shape of the abutting end 212 of the bumper 210, the mobile device 220 can be entirely vertical when inserted into the channel 110 and still cause the bumper 210 to retract. Spring 235 resists the retraction and provides a stabilizing outward force on bumper 210. When bottom end 228 reaches channel floor 120, the bumper 210 urges the mobile device 220 against channel rear wall 114 and support member 130, which provide a resting surface for the back side 222 of device 220.

In addition, the force of the bumper 210 against the mobile device 220 helps to hold the mobile device 220 in place within the channel 110. As explained above, it is possible to implement the bumper 210 with a rubberized polymer material. A similar material could be located on the channel back wall 114 or the support member 130. In this configuration, the force of the spring 230 urges the rubberized bumper 210 against the mobile device 220, which in turn is pressed against the rubberized material on the back wall 114 or the support member 130. This helps to prevent the mobile device 220 from sliding out of position within the channel 110 if the device 220 or speaker stand 110 receives an accidental bump. While these rubberized elements may be made out of a variety of known compositions, it is preferred that the coefficient of friction of these elements be larger than the coefficient of friction of the material forming the walls of the channel 110.

If the support member 130 has a slightly lesser slope away from vertical than the channel rear wall 114, the force of the bumper 210 against the mobile device will be sufficient to flex the support member 130 and conform the slope of the support member 130 to the slope of the channel rear wall 114, causing the two elements 114, 130 to extend approximately along a single plane as shown in FIG. 2. When the rubberized material is placed on this support member 130, this flex will help hold the rubberized material against the rear of the mobile device, thereby increasing the friction holding the device in place within the channel 110.

FIG. 3 shows a top view of an embodiment of the wireless speaker stand 100. In the embodiment of FIG. 3, the channel 110 may be divided into two channel portions 310 and 311, which are separated by an opening 350 in base 101. Because the base 101 is generally circular in shape, this configuration creates a generally donut-like or annular shape to the base. Bumpers 315 and 316 protrude into channel portions 310 and 311 respectively. Bumpers 315, 316 have abutting ends 320, 321 and recessed ends 340, 341. In a preferred embodiment, the ends 320, 321 may each be formed with two adjacent and connected rounded (or arcuate) bumps (or contours). Fixed contact surfaces 330 and 331 within base 101 provide surfaces against which springs 335 and 336 are compressed. Springs 335 and 336 may each comprise a pair of springs aligned with the connected arcuate contours of abutting ends 320, 321. Bumper 316 is shown extended outward into channel 311. Bumper 315 is shown as recessed into base 101, displaced by an urging force 360 exerted against the abutting end 320. Force 360 causes bumper 315 to be retracted into base 110, while springs 335 resist the retraction. In the embodiment of FIG. 3, device 220 need not be inserted in a perfectly straight manner, because bumpers 315, 316 move and adjust independently. Although bumpers 315, 316 are depicted in FIG. 3 as having two connected arcuate contours, they could be shaped in a number of different ways. For example, each bumper could have more or fewer contours, and the contours could be sloped instead of arcuate. One advantage of sloped or arcuate front faces on the bumper is that a downward force by the bottom edge of a mobile device against this sloped or arcuate front is translated by that face into an inward force against the resisting spring, thereby causing retraction of the bumper by a simple downward motion of the mobile device. In this disclosure, a rounded, arcuate front of the bumper as shown in the Figures is considered to be a particular form of a sloped bumper face.

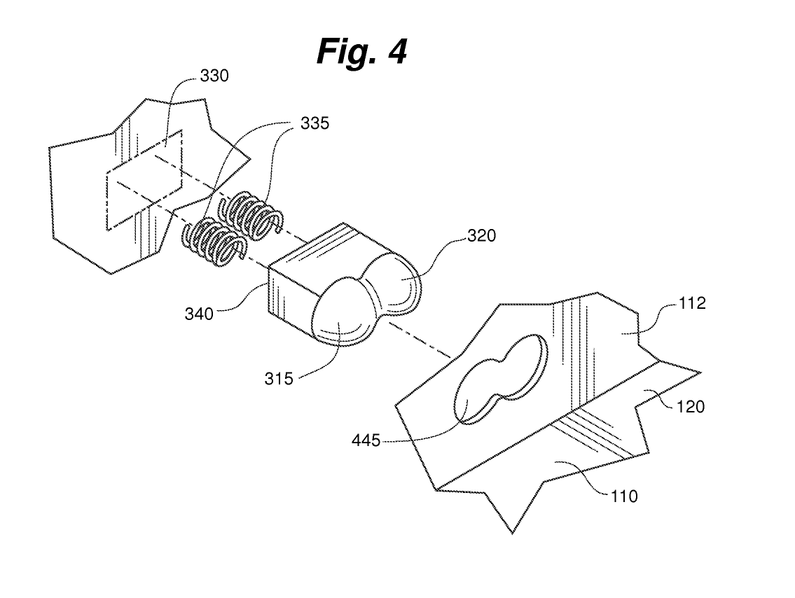

FIG. 4 shows an exploded view of the bumper assembly used in the tablet speaker stand. As shown in FIG. 4, bumper 315 has a recessed end 340 and an abutting end 320. Abutting end 320 may be formed with two adjacent and connected arcuate contours. Contact surface 330 is located within the base 101 of the tablet speaker stand 100. A pair of springs 335 is situated between contact surface 330 and the bumper 315. Preferably, springs 335 are aligned with the contours of abutting end 320. Bumper 315 protrudes into channel 110 through a cutout 445 in channel front wall 112.

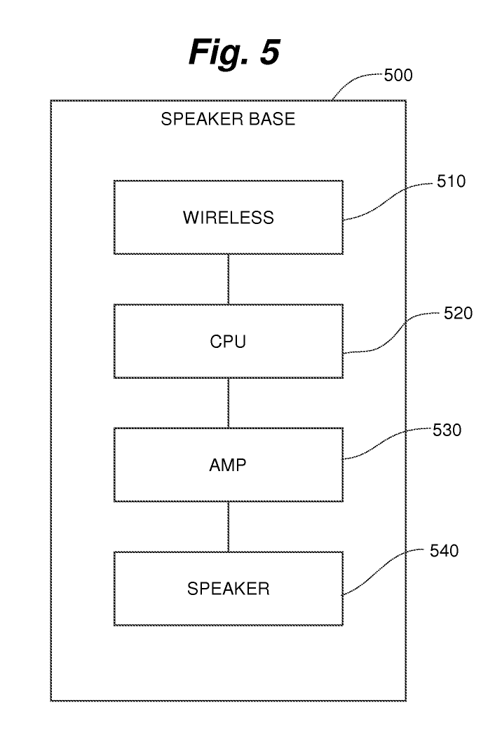

FIG. 5 is a schematic diagram of components within the wireless speaker base 500. The components include wireless communication circuitry 510 for receiving wireless audio signals from a mobile device. The wireless communication 510 could use one of a number of different wireless communication protocols, such as Wi-Fi, Bluetooth, infrared, or other wireless protocols for receiving wireless audio signals. A controller or CPU 520 receives the wireless audio signals and performs functions such as converting digital signals to analog signals. The audio signals are then put through an amplifier 530, and sound is projected out of the speaker component 540.

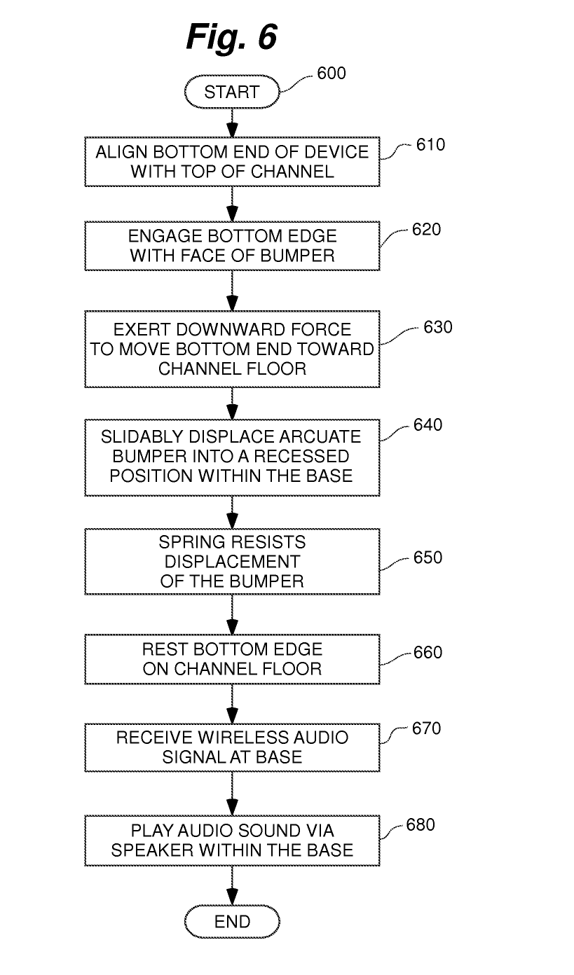

FIG. 6 shows a method of inserting a device into a wireless speaker stand. In step 610, a bottom end 228 of a mobile device 220 is aligned with a top of a channel 110 within the base 101 of the wireless speaker stand 100. In step 620, the bottom end 228 engages the face of a spring-loaded bumper 210. In step 630, a force is exerted on the mobile device 220 to cause the bottom end 228 to move toward channel floor 120. This force against the face of the bumper 210 causes the bumper 210 to be slidably displaced into a recessed position within base 101 (step 640). As this occurs, inward movement of the bumper 210 causes a spring 235 to resist the displacement of the bumper 210 (step 650). In step 660, the bottom end of the mobile device abuts the channel floor 120. In this position, the spring-loaded bumper 210 urges the back face 222 of the mobile device 220 against the channel back wall 114 and the support member 130. This force helps hold the mobile device 220 in place within the channel 110. In step 670, the wireless speaker 100 receives an audio signal at base 101 from mobile device 220, and at step 680, the audio signal is translated into audio sound within speakers of base 101 and played back as audio.

The many features and advantages of the invention are apparent from the above description. Numerous modifications and variations will readily occur to those skilled in the art. For example, the speaker stand could have more or fewer than two bumpers, and the bumpers could have a variety of alternate shapes. Since such modifications are possible, the invention is not to be limited to the exact construction and operation illustrated and described. Rather, the present invention should be limited only by the following claims.

What is claimed is:

1. A wireless speaker stand comprising:
a) a base containing a speaker for outputting sound;
b) a channel intersecting the base, the channel having a channel floor, a channel front wall, and a channel rear wall opposite the channel front wall;
c) a retractable bumper having an abutting end and a recessed end, the recessed end being recessed behind the channel front wall and the abutting end retractably protruding into the channel.

2. The wireless speaker stand of claim 1, wherein the channel rear wall is tilted at an angle of between 20 and 40 degrees away from vertical when the base is resting on a horizontal surface.

3. The wireless speaker stand of claim 1, wherein the bumper is composed of a rubberized material with a higher coefficient of friction than the channel.

4. The wireless speaker stand of claim 2, further comprising a support member extending above the channel rear wall, the support member having a front face forming a plane with the channel rear wall.

5. The wireless speaker stand of claim 2, further comprising a support member extending above the channel rear wall, the support member having an angle away from vertical being slightly less than the angle of the channel rear wall.

6. The wireless speaker stand of claim 5, wherein the bumper is composed of a rubberized material with a higher coefficient of friction than the channel and further wherein a second rubberized material is found on the support member.

7. The wireless speaker stand of claim 1, wherein the abutting end of the bumper has a sloped face.

8. The wireless speaker stand of claim 1, further comprising a first spring providing tension between the bumper and a contact surface behind the channel front wall when a retracting force is exerted upon the abutting end of the bumper

9. The wireless speaker stand of claim 8, further comprising a second spring adjacent to the first spring, the second spring providing tension between the bumper and the contact surface, and further wherein the abutting end of the bumper has a face having a pair of adjacent contoured faces.

10. The wireless speaker stand of claim 1, wherein the base comprises:
i) a wireless communication interface receiving a digital wireless audio signal from a mobile device, and
ii) a computer processor that converts the digital wireless audio signal into an analog audio signal, and
iii) an amplifier that amplifies the analog audio signal and outputs the amplified audio signal to the speaker.

11. The wireless speaker stand of claim 1, wherein the base has a generally annular shape with the channel separated into two separate sub-channels by a center opening in the base, further wherein the bumper is found in a first sub-channel and a second retractable bumper is located within a second sub-channel.

12. A system for supporting a mobile device, the system comprising:
a) the mobile device having
i) a front side,
ii) a back side, and
iii) a bottom end; and
b) a mobile device stand having
i) a base,
ii) a channel intersecting the base and having a rear channel wall, the channel receiving the bottom end of the mobile device, and
iii) a spring-loaded bumper retractably protruding into the channel, the bumper exerting a force on the front side of the mobile device pressing the back side of the mobile device against the rear channel wall.

13. The system of claim 11, wherein the mobile device stand further comprises a support member extending above the rear channel wall, the support member being attached to the base and abutting the back side of the mobile device.

14. The system of claim 11, wherein the mobile device further comprises a wireless data transmission interface transmitting wireless audio signals to the mobile device stand, and the mobile device stand further comprises a wireless data receiving interface receiving the wireless audio signals and converting the wireless audio signals to audio sound via audio speakers within the mobile device stand.

15. A method for placing a mobile device into a stand, comprising:
a) inserting a bottom side of the mobile device into a top of a channel within a base of the stand;
b) abutting one edge of the bottom side against a front, sloped face of a bumper embedded within the channel;
c) pressing the edge of the bottom side against the sloped face of the bumper, causing the bumper to move into a wall of the channel against a force provided by a spring; and
d) sliding the mobile device to a bottom of the channel, with the bumper pushing against a front face of the mobile device.

16. The method of claim 15, further comprising pressing a rubberized material found on the face of the bumper against the front face of the mobile device.

17. The method of claim 15, further comprising:
e) supporting a back surface of the mobile device against a supporting member of the stand, the supporting member extending above the channel.

18. The method of claim 17, wherein the step of supporting a back surface of the mobile device against a supporting member of the stand further comprises flexing the supporting member so as to cause the supporting member to align with a plane formed by a back wall of the channel.

19. The method of claim 18, further comprising pressing a first rubberized material found on the face of the bumper against the front face of the mobile device while pressing a rear face of the mobile device against a second rubberized material found on at least one of the back wall of the channel and the supporting member.
